(19) United States
(12) Patent Application Publication
(10) Pub. No.: US 2013/0134071 A1
(43) Pub. Date: May 30, 2013

(54) DEVICE AND METHOD FOR EXAMINING MOVING TABLETS

(71) Applicant: Uhlmann PAC-Systeme GmbH & Co. KG, Laupheim (DE)

(72) Inventor: Anton Singer, Laupheim (DE)

(73) Assignee: Uhlmann PAC-Systeme GmbH & Co. KG, Laupheim (DE)

(21) Appl. No.: 13/649,225

(22) Filed: Oct. 11, 2012

(30) Foreign Application Priority Data
Oct. 13, 2011 (EP) EP 11185074.9
Mar. 5, 2012 (EP) EP 12158140.9

(51) Int. Cl. B03C 7/00; G01N 27/61

(52) U.S. Cl. CPC B03C 7/00; G01N 27/61
USPC 209/3.2; 324/456

(57) ABSTRACT

The device for examining moving tablets comprises a discharging device for discharging the tablets conducted past it, a charging device arranged downstream from the discharging device for charging the discharged tablets conducted past it, and a charge detector arranged downstream from the charging device to detect the charges produced on the tablets.

### RELATED APPLICATIONS

The present patent document claims the benefit of priority to European Patent Application No. EP 11185074.9, filed Oct. 13, 2011, and EP 12158140.9, filed Mar. 5, 2012, the entire contents of each of which are incorporated herein by reference.

### FIELD AND BACKGROUND OF THE INVENTION

The present invention relates to a device and to a method for examining moving tablets.

Devices and methods of this type are used in the pharmaceutical industry to count tablets as they are being transferred to containers, for example, or, in more complex embodiments, to examine the color, shape, and in some cases even the ingredients of the tablets.

A technique used frequently for this purpose is to drop the tablets or actively to move them between the opposing plates of a capacitor charged with a high-frequency alternating field. The passage of the tablet induces on the capacitor plates a dipole moment, which can be read by a suitable sensor. A device of this type is known, for example, from US 2009/0056825 A1.

Another design of a capacitive sensor of this type with more than two capacitor plates, which otherwise works according to the same principle as that just described above, is known, for example, from U.S. Pat. No. 6,504,387 B1.

The disadvantage of all these capacitive measurement methods is primarily that, to ensure that useful measurement results within acceptable tolerances can be obtained, the tablets must maintain a defined orientation as they are passing through the detector. The measurement results will deviate in particular when the tablets are rotating or when they depart from a certain favorable path, which means that the reliable detection of broken tablets and their subsequent ejection cannot be guaranteed under all circumstances.

### SUMMARY OF THE INVENTION

It is an object of the present invention to provide a device for examining moving tablets which can detect and evaluate the tablets regardless of their previous history within the packaging process and also regardless of their orientation in the sensor field and which can guarantee the reliable detection of broken tablets even at high throughputs. In addition, a corresponding method for examining moving tablets is also to be provided.

According to the invention, the device for examining moving tablets comprises a discharging device for discharging the tablets conducted past it; a charging device arranged downstream from the discharging device for charging the discharged tablets conducted past it; and a charge detector arranged downstream from the charging device to detect the charges on the tablets imposed by the charging device.

With this design, it is possible to conduct a trouble-free and reliable differentiation with respect to size between good and bad tablets regardless of the influences to which the individual tablet has been subjected before entering the device for examining moving tablets and regardless of its orientation in the sensor field.

The charge detector is preferably connected to an evaluation unit, which, on the basis of the values measured by the charge detector, actuates a sorting device for the tablets installed downstream from the charge detector. In this way, defective tablets can be ejected immediately after they have been detected in an especially reliable manner.

Installing the charging device directly downstream from the discharging device or close to it effectively prevents a falsification of the measurement results.

The discharging device is preferably set up in the area of an oscillating conveyor for the tablets and is designed as an ionizing rod. In this way, the tablets can be discharged easily and quickly.

An undesired charging or discharging of the tablets downstream from the charging device is effectively prevented by installing the charging device in a filling tube for the tablets, preferably directly upstream of the charge detector.

In a preferred embodiment, the charging device comprises a grounded housing and a shielded high-voltage cable, which is connected to a high voltage source, wherein the shielded high-voltage cable terminates in a discharge tip in the interior of the housing. The charge can thus be effectively transferred to the tablets.

The generated ion wind can be directed even more effectively by setting up the discharge tip so that it projects into a conical cavity in a plastic block inside the housing, the cavity being open at the bottom.

The charging device will operate especially reliably and uniformly if it acts on the tablets from two opposite sides.

The charge detector preferably comprises a sensor element designed as a hollow body having a closed surrounding jacket of conductive material, an open entrance side at the top and an open exit side at the bottom. In its interior space, the sensor element defines a continuous path for the tablets extending from the entrance side to the exit side. In addition, the jacket is grounded via a resistor. The charge detector also comprises at least one pickup element arranged near the outside surface of the jacket of the sensor element. This pickup element consists of conductive material and is galvanically isolated from the outside surface of the jacket of the sensor element. This makes it possible for the charge detector to classify the tablets reliably regardless of the exact point at which they pass through the sensor and regardless of their orientation.

The evaluation can be improved by preferably connecting the pickup element to a converter and/or amplifier unit, which receives the voltage pulses generated in the pickup element as the tablets pass through the sensor element and converts or amplifies them to form an evaluable signal.

The device preferably also comprises an evaluation unit for evaluating the signals coming from the converter or amplifier unit so that a downstream sorting device can be actuated effectively. This evaluation unit is able to compare the nominal values of the converter or amplifier unit obtained for a certain type of tablet with the actual values supplied by the converter or amplifier unit.

The sensor element is preferably formed as a short, hollow cylinder with a substantially circular cross section. Thanks to the circular form, the charges become uniformly spaced around the outside surface of the jacket of the sensor element as a tablet is passing through the sensor element. As a result, the charge can be detected at any desired point on the outside surface of the jacket without any deviation in the measurement results. A sensor element with a rectangular, especially a square, cross section is also suitable.

An especially suitable material for the jacket of the sensor element is a conductive metal, especially high-grade steel or aluminum.

Because the charge density on the outside surface of the jacket changes as a function of the size of the tablet, preferably several pickup elements with their associated converter or amplifier units are distributed around the outside surface of the jacket of the sensor element, wherein the pickup or evaluation electronic of each sensor is calibrated differently so that tablets of different sizes can be detected by the same sensor design.

The galvanic isolation between the sensor element and the pickup element is preferably achieved by an insulating element in the form of an insulating layer on the pickup element.

The jacket of the sensor element preferably comprises a thickness in the range of 0.2-0.8 mm and a diameter in the range of 10-60 mm. The distance between the entrance side and the exit side is preferably in the range of 5-20 mm. With these geometric dimensions, it is possible to detect a large number of different tablet shapes reliably and without any additional adjustments.

Installing a resistor in the range of 10-500 MΩ, preferably of 200-300 MΩ, between the jacket and ground prevents the buildup of an electrostatic charge, which would cause the signal to drift. At the same time, the resistor is necessary to ensure that the electric charges do not dissipate immediately, because otherwise the pickup element would not be able to detect any induction effect at all.

The pickup element is preferably designed as a plate, the jacket-facing surface of which comprises an area of approximately 5×5 mm. In this way, it is very easy to produce a charge separation in the pickup element which corresponds to the original information present in the interior of the sensor element.

According to another aspect of the invention, the method for examining moving tablets comprises the following steps:

discharging tablets in a discharging device as they are conducted past it;

charging the discharged tablets in a charging device as they are conducted past it; and

detecting the charges imposed on the tablets by the charging device in a charge detector.

This examination method is extremely robust and reliable.

An evaluation unit preferably actuates a sorting device for the tablets installed downstream from the charge detector on the basis of the values measured by the charge detector. This guarantees that defective tablets will be ejected immediately after they have been detected.

It is especially preferred in this respect to carry out the step of charging immediately after the step of discharging and to prevent any further charging or a discharging of the tablets between the step of charging and the step of detecting the charges.

### BRIEF DESCRIPTION OF THE DRAWINGS

Additional features and advantages of the present invention can be derived from the following description referring to the drawings.

FIG. 1 is a schematic cross-sectional view of an embodiment of the device for examining moving tablets according to the invention;

FIG. 2 is a graph of the possible changes in the charge on a tablet in the various stations of a packaging operation during the use of the device for examining tablets according to the invention;

FIG. 3 is a schematic view of an embodiment of the discharging device;

FIG. 4 is a schematic view of an embodiment of the charging device;

FIG. 5 is a schematic cross-sectional view of an embodiment of the charge detector through which a tablet is falling;

FIG. 6 is a cross-sectional view of the charge detector of FIG. 5 in a plane perpendicular to the viewing plane of FIG. 5, including an enlarged detail;

FIGS. 7a-7c are voltage graphs obtained with the device for examining moving tablets according to the invention;

FIG. 8 is a schematic cross-sectional view of a first embodiment of a tablet packaging unit with an integrated device for examining moving tablets according to the invention; and

FIG. 9 is a schematic cross-sectional view of a second embodiment of a tablet packaging unit with an integrated device for examining moving tablets according to the invention.

### DETAILED DESCRIPTION OF SPECIFIC EMBODIMENTS

In the following, the term “tablet” is to be understood as any form of pharmaceutical product which is solid and contains pharmaceutically active ingredients. Examples include coated tablets, oblongs, capsules, etc.

The present invention is based on the principle of the detection of charges, preferably negative charges, which collect on the surface of tablets and which are detected as the tablets pass through a charge detector.

Tablets usually develop a charge during the course of the packaging process such as during the transport of the tablets along a vibrating chute or at some other point of the transport route. This charge is attributable primarily to friction. This preexisting electrostatic charge of the tablets, however, is highly variable. Positive and negative values extending over a range from 100 kV/m to 2 MV/m can occur, which means that the measurement results cannot be used to distinguish between good and bad tablets. According to the invention, therefore, the tablets are discharged first, then specifically charged, and finally detected by means of a charge detector.

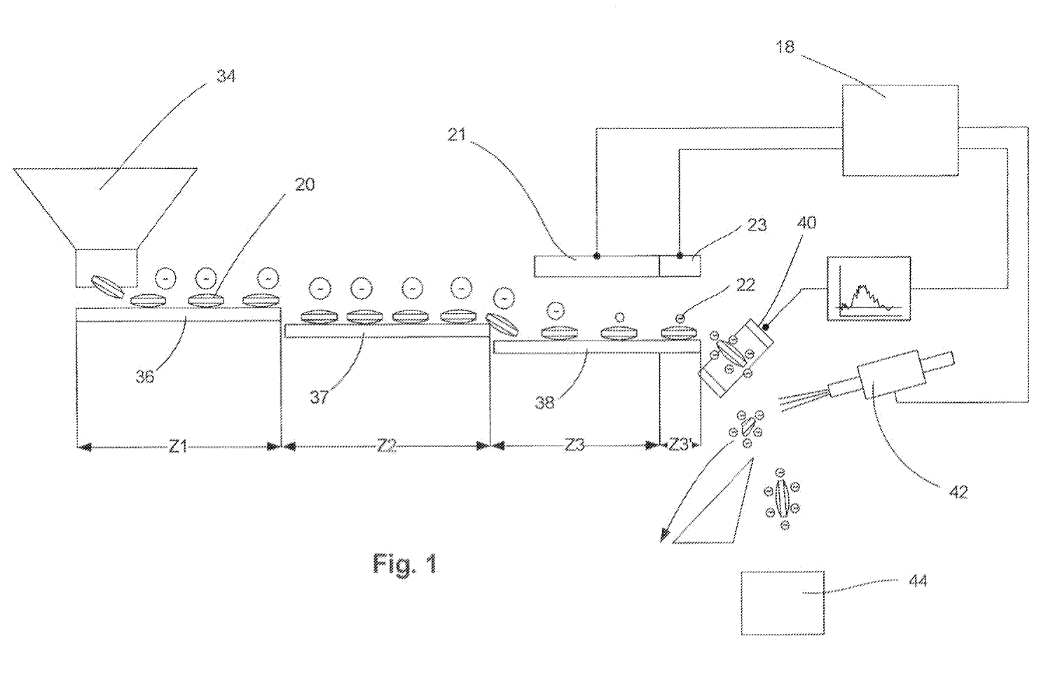

FIG. 1 shows an example of the design of a packaging system with a device for examining moving tablets according to the present invention. The sequence of events will now be described below.

The tablets 20 are first stored in bulk form in a supply container 34. From there they are sent to a conveying device, which spaces the tablets apart from each other at least to some extent. In the present case, the conveying device is an oscillating conveyor with three stages or sections 36, 37, 38. The tablets 20 are now effectively discharged, preferably in the area of the last section 38 of the oscillating conveyor, by means of a discharging device 21. In other words, their electrostatic charges are neutralized. Then they are specifically charged with a charge 22 by means of a charging device 23 installed downstream of the discharging device 21. This charge 22 is selected in correspondence with the purpose to be achieved, but as a rule it is not particularly large, so that it does not have a negative influence on the further course of the packaging process. The separated tablets 20 then pass through a charge detector 40, which measures the defined electrostatic charge 22 as the tablets pass through. These measurement values are transmitted to an evaluation unit 18. The evaluation unit 18 examines the validity of the tablets 20, as will be described in greater detail further below, and on that basis actuates a sorting device 42 for separating the good tablets 20 from the bad ones. The good tablets then arrive in the desired containers 44, preferably cans or bottles. In addition to the examination of the validity of the tablets 20, the charge detector 40 can also be used to count the (good) tablets.

In the case illustrated here, the sorting device 42 is formed as an air blast nozzle, which pushes the bad tablets 20 to one side, but it could also be designed in some other way, such as in the form of a mechanical switch. It would also be possible for the sorting device 42 to deflect the good tablets 20 from their normal path, so-called “separation of the good”.

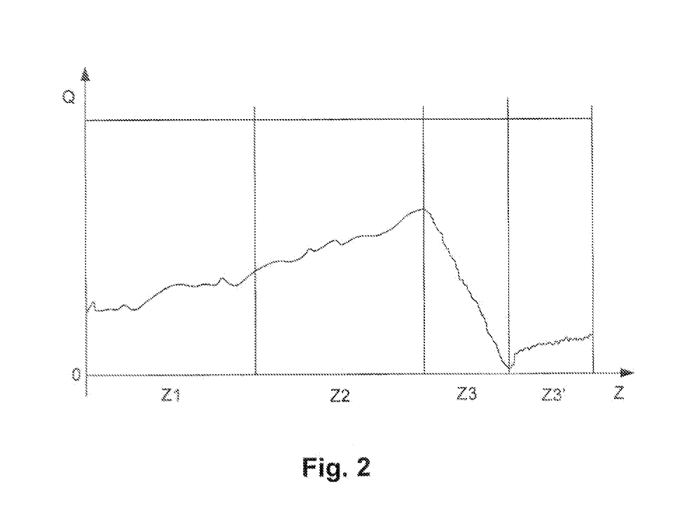

FIG. 2 shows by way of example a graph of the electrostatic charge Q of a tablet 20 in various zones Z of the conveying device. Zone Z1 corresponds here to the first section 36 of the oscillating conveyor, zone Z2 corresponds to the second section 37 of the oscillating conveyor, zone Z3 corresponds to the area of the third section 38 of the oscillating conveyor which is in front of the charging device 23, and zone Z3′ corresponds to the area of the third section 38 of the oscillating conveyor in which the charging device 23 is installed.

As can be seen in the example, the degree to which the tablets 20 are charged increases continuously in zones Z1 and Z2 as a result of friction. Then this arbitrary, undesirable charge is reduced to virtually zero in zone Z3 by the discharging device 21. Finally, in zone Z3′, the charging device 23 gives the tablets 20 a slight, predetermined charge 22, upon which the following evaluation is based.

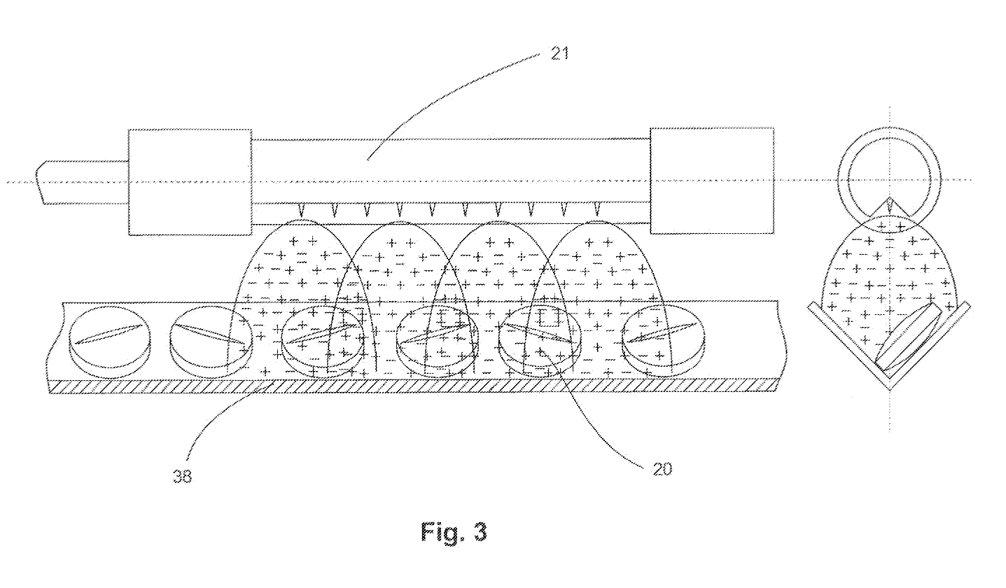

FIG. 3 shows an embodiment of the discharging device 21. In section 38 of the oscillating conveyor, the charged tablets 20 are conveyed under the discharging device 21, which is designed here as an ionizing rod. The discharging device 21 generates alternating positive and negative ions, which are attracted by the opposite charges on the tablets 20. The surfaces of the tablets 20 are thus discharged or neutralized. Excess ions of the two polarities are given off to the grounded metal section 38 of the oscillating conveyor and neutralized.

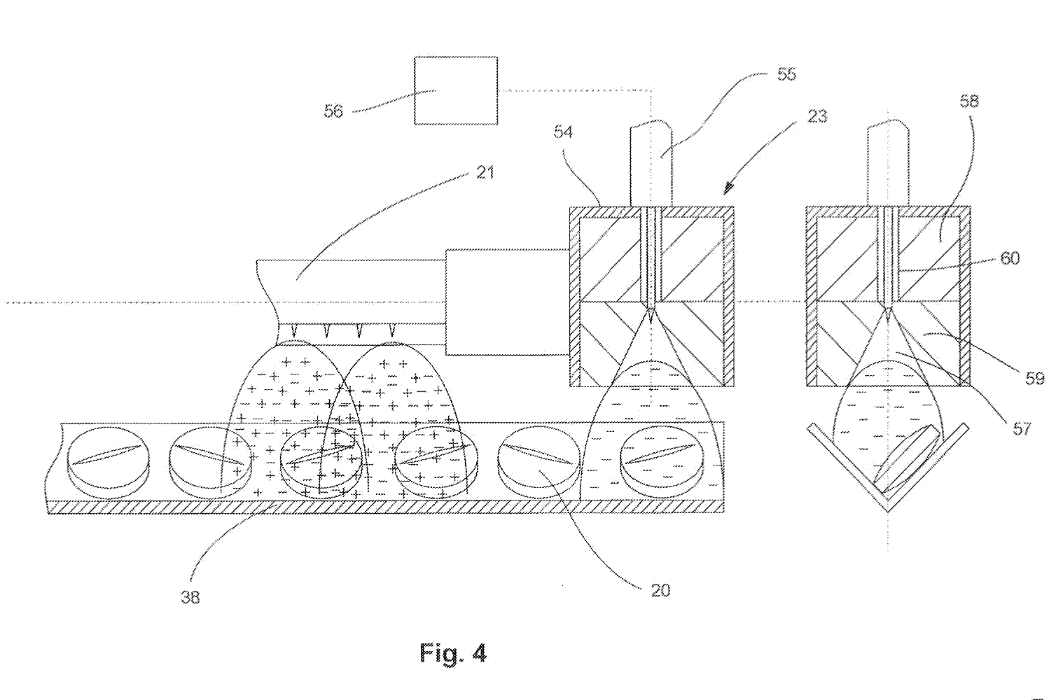

FIG. 4 shows an embodiment of the charging device 23. The tablets 20 neutralized by the discharging device 21 are conveyed along section 38 of the oscillating conveyor to the charging device 23. The charging device 23 consists of a shielded, grounded metal housing 54 and a shielded high-voltage cable 55, which is connected to a high voltage source 56. The shielded high-voltage cable 55 is guided through two plastic blocks 58, 59 and terminates in a discharge tip 60. The discharge tip 60 projects into a conical cavity 57 in the block 59. When a high-voltage, preferably in the range of 5-10 kV, is applied, an ion wind consisting of negative ions is created at the discharge tip 60 and streams toward the tablets 20. The surfaces of the neutral tablets 20 take up the negative ions. Thus a defined charge density is formed on the tablets 20.

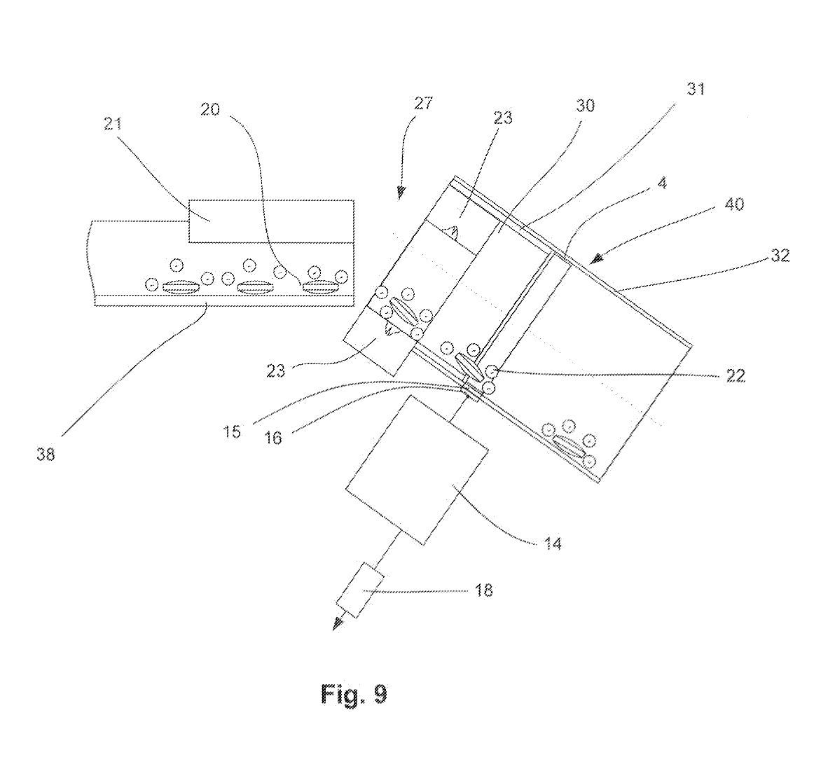

The charging device 23 and the discharging device 21 could both be designed in various other ways. In particular, the charging device 23 can charge the tablets 20 from several sides, preferably from two opposite sides. In addition, the charging device 23 can be integrated into a filling tube 30. Both of these latter details are shown in FIG. 9.

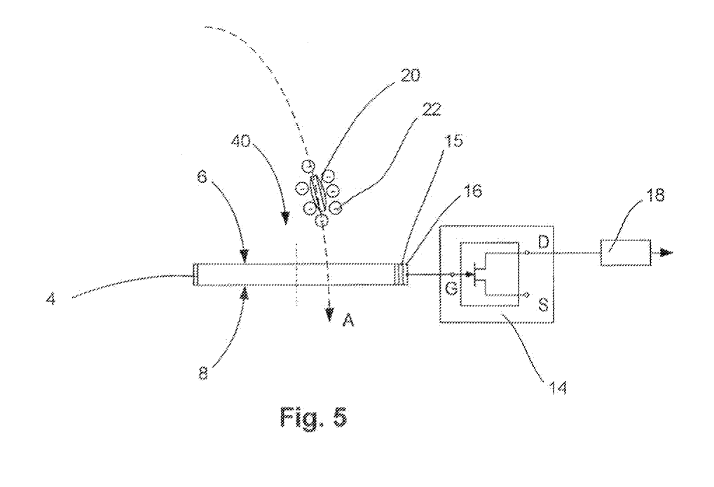

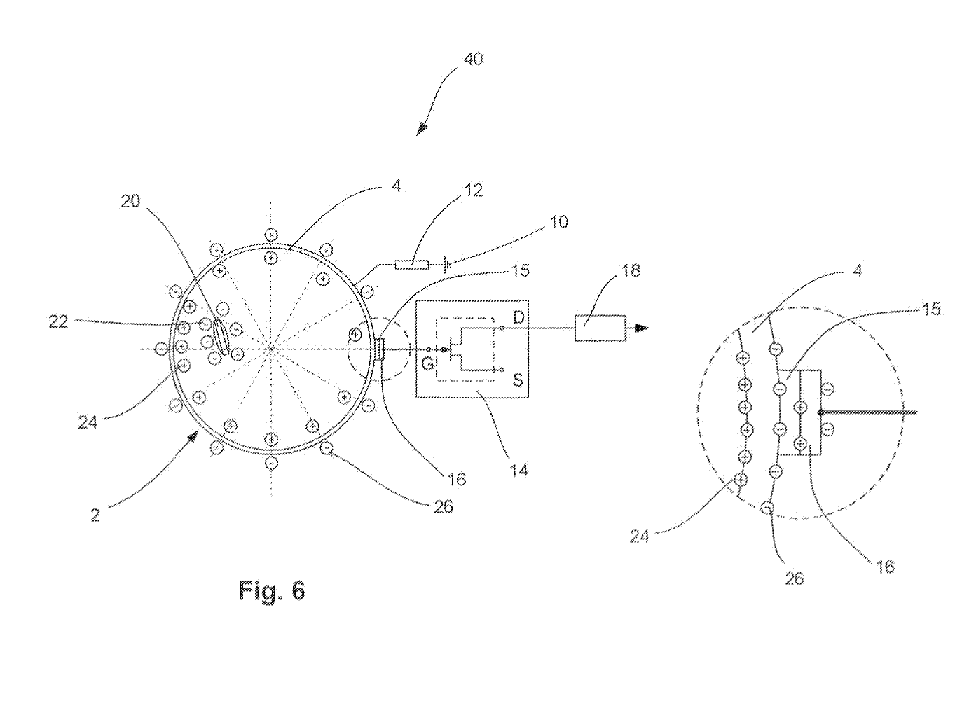

FIGS. 5 and 6 show two different views of an embodiment of the charge detector 40. The charge detector 40 comprises a sensor element 2, which is formed as a hollow body and which comprises a closed surrounding jacket 4 of conductive material. The sensor element 2 also comprises an open entrance side 6 at the top and an open exit side 8 at the bottom. In the preferred embodiment shown, the sensor element 2 is designed as a short hollow cylinder with a substantially circular cross section. In a different embodiment, the cross section of the sensor element 2 can be rectangular, and in particular it can be square.

The jacket 4 of the sensor element 2 is preferably made of metal such as high-grade steel or aluminum. The jacket 4 preferably comprises a thickness in the range of 0.2-0.8 mm and a diameter in the range of 10-60 mm. The distance between the entrance side 6 and the exit side 8 of the sensor element 2 is preferably in the range of 5-20 mm.

The jacket 4 of the sensor element 2 is grounded via a resistor 12, preferably a high-ohmic resistor. For this purpose, the outside surface of the jacket 4 is connected to ground 10 via the resistor 12. The resistor 12 has a resistance in the range of 10-500 MΩ, preferably in the range of 200-300 MΩ.

The charge detector 40 also comprises at least one pickup element 16 of conductive material arranged near the outside surface of the jacket 4 of the sensor element 2. The signals generated by this pickup element 16 are processed by a converter and/or amplifier unit 14.

The pickup element 16, like the jacket 4 of the sensor element 2, is made of metal, preferably of high-grade steel or aluminum. The pickup element 16 is preferably formed as a plate. The surface of this plate which faces the jacket 4 preferably has an area of approximately 5×5 mm.

The pickup element 16 is isolated galvanically from the outside surface of the jacket 4 of the sensor element 2. An insulating element 15, preferably in the form of an insulating layer on the pickup element 16, is used to isolate the sensor element 2 galvanically from the pickup element 16. This layer can be provided in the form of a strip of insulating adhesive tape, for example. Many other types of insulating elements 15, however, can also be considered.

Several pickup elements 16 can also be arranged around the outside surface of the jacket 4 of the sensor element 2. In this case, preferably the same number of converter or amplifier units 14 will also be provided. Each sensor path is preferably calibrated differently. The converter or amplifier unit 14 can be designed in a wide variety of ways. The important point here is that the charge separation caused by double induction in the pickup element 16 upon passage of a tablet 20 through the sensor element 2 is subjected to further processing, wherein the voltage pulses in the pickup element 16 serve as the starting point for the further conversion/amplification.

In the embodiment shown here by way of example, the converter or amplifier unit 14 is an FET transistor, the gate G of which is connected to the pickup element 16. Other types of transistors, possibly with additional voltage terminals, are also conceivable. It is also possible to conduct additional signal processing measures (inversion, smoothing, potentiation, etc.) upstream or downstream of the converter or amplifier unit 14.

The converter or amplifier unit 14 is preferably connected to an evaluation unit 18 for evaluation of the signals generated by the converter or amplifier unit 14. This evaluation unit 18 is able to compare the nominal values of the converter or amplifier unit 14 obtained for a certain type of tablet with the actual values supplied by the converter or amplifier unit 14. In the example shown here, the signal from the drain D of the FET transistor is sent to the evaluation unit 18. On the basis of the result of the evaluation unit 18, it is then possible to actuate the sorting device 42 for the tablets 20 shown in FIG. 1.

In the following, the principle on which the charge detector 40 operates will be described on the basis of FIGS. 5 and 6. On passage through the charge detector 40, the tablets 20 are carrying a defined electrostatic charge 22, preferably a negative charge, as a result of the preceding discharging and the following specific slight charging. Because the surface areas of intact tablets 20 differ from those of broken ones, the corresponding individual charges will also be different, as will the electrical field strengths on their surfaces. The charge detector 40 can now use this charge as a means of examining the tablets 20.

The tablet 20 now moves along a continuous path A through the sensor element 2. In the example of FIG. 5, this is done simply in free fall. As the tablet 20 passes through the interior space of the sensor element 2 from the entrance side 6 to the exit side 8, the charges 22 which are present on the tablets 20 generate by induction a charge separation in the electrically conductive jacket 4 and thus an accumulation of charges 24 on the internal surface of the jacket 4 (FIG. 6) with signs opposite those of the charges 22 on the tablets 20. In other words, as the tablets 20 fall through the sensor element 2, their electrostatic fields create a charge separation by induction. The charge density of the charges 24 generated by the charge separation on the internal surface of the jacket 4 is greater in the immediate vicinity of the electrically charged tablet 20 than it is in areas of the internal surface of the jacket 4 which are farther away, as can be seen in FIG. 6.

On the outside surface of the jacket 4, however, the charge separation allows the charges 26, the signs of which are the same as those of the charges 22 of the tablet 20, to shift their locations. In the case of a ring-shaped jacket 4, the charge density on the outside surface of the jacket 4 therefore becomes uniform.

This means that equal-sized subsections of the outside surface of the jacket 4 all have the same partial electric field strength, and the sum of these partial field strengths is the same as the electrostatic field strength present in the interior of the jacket 4. The level of the charge density on the outside surface of the jacket 4 is determined by the charge 22 of the falling tablet 20. The partial field strength in each section of the outside surface of the jacket 4 is therefore directly proportional to the charge of the tablet 20 passing through the sensor element 2.

Because the jacket 4 is in the form of a ring, i.e., because it has a circular cross section, the exact point where the tablet 20 passes through the interior space of the sensor element 2 has no effect on the electrostatic field strength generated in each of the subsections of the outside surface of the jacket 4.

This uniform electrostatic field strength on the outside surface of the jacket 4, which contains the original information of the charge of the tablet 20, now brings about in turn, by induction, a charge separation in the electrically conductive pickup element 16, as can be seen especially clearly in the enlarged diagram on the right in FIG. 6.

The voltage pulses thus arising are converted and/or amplified as appropriate in the converter and/or amplifier unit 14 and transmitted to the evaluation unit 18. The important point here is that the pickup element 16 and the jacket 4 are galvanically isolated from each other. The high-ohmic grounding of the jacket 4 via the resistor 12 prevents the buildup of an electrostatic charge, which would result in a signal drift. At the same time, the resistor 12 ensures that the electrical charges 26 forming on the outside surface of the jacket 4 do not dissipate immediately, so that the pickup element 16 is able to detect an induction effect at all.

The evaluation unit 18 now compares the actual values transmitted from the converter or amplifier unit 14 with stored nominal values for a corresponding type of tablet. The nominal values can be obtained preferably by test runs with intact tablets as part of a calibration procedure.

A deviation from the given nominal value (e.g., with respect to the signal amplitude or the integral of the signal curve) by a predetermined amount or percentage makes it possible for the sensor element 2 to detect a falling broken tablet and for the downstream sorting device 42 (FIG. 1) to remove the broken tablet. Because the charge alternations occur very quickly, each tablet 20 can be evaluated before the next tablet 20 reaches the sensor element 2.

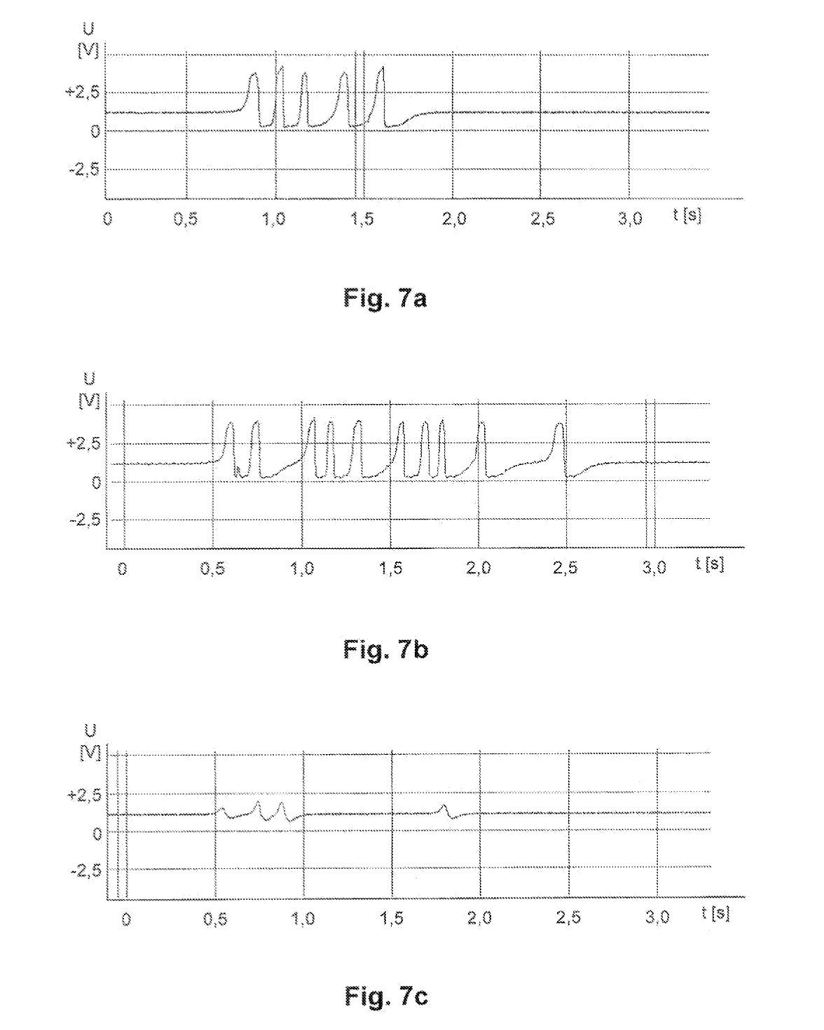

FIG. 7a shows the plot of the voltage signals (in V) coming from the converter or amplifier unit 14 versus time (in s) for five intact tablets. It is easy to see the almost completely uniform shape and height of the corresponding peaks.

FIG. 7b shows an identical graph for ten intact tablets, whereas FIG. 7c shows the graph for four pieces of broken tablets. Provided that a suitable threshold value is selected, it is therefore possible to detect every clinically relevant instance of tablet breakage and thus to eject the corresponding broken tablets. It is especially important to note here that neither the orientation of the tablet, its trajectory, nor the exact point where it passes through the sensor element 2 has any significant effect on the measurement result.

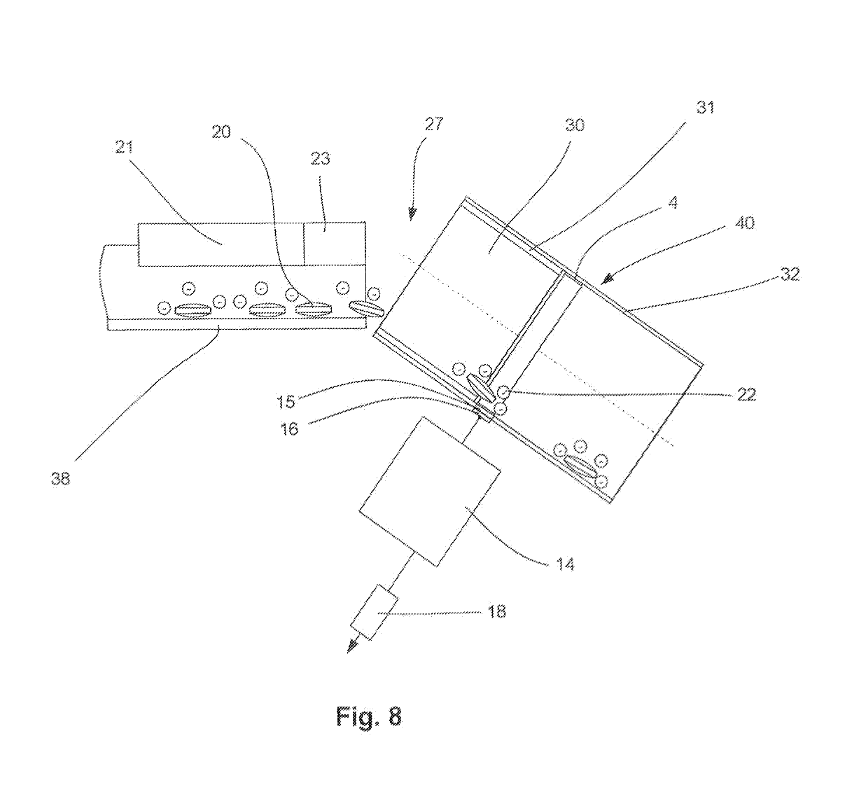

FIG. 8 shows an especially preferred arrangement of the charge detector 40 in a tablet packaging unit 27. The tablet packaging unit 27 comprises again the last section 38 of an oscillating conveyor, by which the tablets 20 are transported to a filling tube 30. The sensor element 2 of the charge detector 40 is now integrated into the jacket 32 of the filling tube 30. The jacket 32 will usually consist of insulating plastic. In the filling tube 30, upstream of the sensor element 2, a collar-like insert 31 of metal can be provided, over which the tablets 20 slide. For the sake of clarity, not all of the elements of the device for examining moving tablets are shown. Nevertheless, the design of the device corresponds to that of the device shown in FIG. 1.

The important aspect of this embodiment is that the jacket 4 of the sensor element 2 is set back slightly from the upstream interior section of the filling tube 30, i.e., from the inside surface of the insert 31 in the examples shown here, so that the tablets 20 do not touch the inside surface of the jacket 4 as they pass through the filling tube 30. If they did, the measurements would be falsified. Accordingly, the inside radii of the jacket 32, i.e., the radius of the insert 31 in the filling tube 30 and the radius of the jacket 4 of the sensor element 2, must be selected properly with respect to each other. In addition, the angle of the filling tube 30 and the speed of the tablets 20 are also factors which must be considered. Aside from that, the way in which the device examines moving tablets is identical to that described above.

FIG. 9 shows a similar arrangement of the charge detector 40 in a tablet packaging unit 27. The charging device 23 is also integrated into the filling tube 30, whereas the discharging device 21 is arranged at the end of the oscillating conveyor. In the example shown here, the charging device 23 acts from two opposite sides on the tablets 20, which ensures an especially uniform charging effect.

In the preferred embodiment of the charge detector 40 shown here, only one pickup element 16 has been illustrated so far. It is possible, however, to provide several pickup elements 16, such as two or four pickup elements 16, and to distribute them uniformly around the sensor element 2. The circular shape of the jacket 4 of the sensor element 2 can also be modified in the direction of ovality or toward a rectangle. Finally, the pickup element 16 can be farther away from the jacket 4 than shown in the drawing.

1. A device for examining moving tablets, comprising:
a discharging device for discharging the tablets conducted past it;
a charging device arranged downstream from the discharging device for charging the discharged tablets conducted past it; and
a charge detector, arranged downstream of the charging device, to detect the charges imposed on the tablets by the charging device.

2. The device according to claim 1, wherein the charge detector is connected to an evaluation unit, which controls a sorting device for the tablets downstream from the charge detector on the basis of values measured by the charge detector.

3. The device according to claim 1, wherein the charging device is arranged directly downstream from the charging device or close to it.

4. The device according to claim 1, wherein the discharging device is arranged in an area of an oscillating conveyor for the tablets and is formed as an ionizing rod.

5. The device according to claim 1, wherein the charging device is arranged in a filling tube for the tablets.

6. The device according to claim 1, wherein the charging device comprises a grounded housing and a shielded high-voltage cable, which is connected to a high voltage source, wherein the shielded high-voltage cable terminates in a discharge tip inside the housing.

7. The device according to claim 6, wherein the discharge tip projects into a conical cavity in a plastic block inside the housing.

8. The device according to claim 1, wherein the charge detector comprises a sensor element formed as a hollow body having a closed surrounding jacket of a conductive material, an open entrance side at a top and an open exit side at a bottom, wherein the sensor element defines in an interior space thereof a continuous path for the tablets extending from the entrance side to the exit side, wherein the jacket is grounded via a resistor, and wherein the charge detector also comprises at least one pickup element of conductive material arranged near an outside surface of the jacket of the sensor element, the pickup element being galvanically isolated from the outside surface of the jacket of the sensor element.

9. The device according to claim 8, wherein the pickup element is connected to a converter or amplifier unit, which receives voltage pulses generated in the pickup element upon passage of a tablet through the sensor element and converts or amplifies them to form an evaluable signal.

10. The device according to claim 9, wherein the evaluation unit is adapted to receive signals from the converter or amplifier unit and to compare nominal values of the converter or amplifier unit obtained for a certain type of tablet with actual values supplied by the converter or amplifier unit.

11. The device according to claim 8, wherein the sensor element is formed as a short hollow body with a substantially circular or rectangular cross section.

12. The device according to claim 8, wherein several pickup elements are distributed around the outside surface of the jacket of the sensor element.

13. A method for examining moving tablets, comprising:
discharging tablets in a discharging device as they are conducted past it;
charging the discharged tablets in a charging device as they are conducted past it; and
detecting the charges produced on the tablets by the charging device in a charge detector.

14. The method according to claim 13, wherein an evaluation unit actuates a sorting device for the tablets arranged downstream from the charge detector on the basis of values measured by the charge detector.

15. A method according to claim 13, wherein the step of charging is carried out immediately after the step of discharging, and wherein, between the step of charging and the step of detecting the charges, any further charging or a discharging of the tablets is prevented.
